(19) United States
(12) Patent Application Publication
(10) Pub. No.: US 2025/0026988 A1
(43) Pub. Date: Jan. 23, 2025

(54) CONTROLLED TURBOCHARGER IN GAS-OIL SEPARATION PLANT INLET MANIFOLD

(71) Applicant: SAUDI ARABIAN OIL COMPANY, Dhahran (SA)

(72) Inventors: Abdullah S. ALHUSSAIN, As Saffaniyah (SA); Shahid M. ALHINDI, As Saffaniyah (SA); Mogib M. ALSHAHRANI, As Saffaniyah (SA)

(73) Assignee: SAUDI ARABIAN OIL COMPANY, Dhahran (SA)

(21) Appl. No.: 18/356,097

(22) Filed: Jul. 20, 2023

(51) Int. Cl. C10G 33/08; B01D 17/02; B01D 17/12; C02F 1/00; C02F 1/40; C10G 33/06

(52) U.S. Cl. CPC C10G 33/08; B01D 17/0214; B01D 17/12; C02F 1/008; C02F 1/40; C10G 33/06; C02F 2101/32; C02F 2103/10; C10G 2300/208; C10G 2400/06

(57) ABSTRACT

A gas-oil separation plant (GOSP) system includes a crude inlet line for a fluid inlet stream. An inlet pressure control valve is coupled within the crude inlet line to control a pressure of the fluid inlet stream passing therethrough. A separation vessel is provided downstream of the inlet pressure control valve and is operable to separate a water component from the inlet fluid stream. The GOSP system further includes a water line coupled to the separation vessel and a water draw-off pump including a shaft operably rotatable to draw the water component through the water line from the separation vessel. A turbine is coupled upstream of the inlet pressure control valve and includes a turbine shaft rotatable in response to the inlet fluid stream flowing therethrough. The turbine shaft is operably coupled to the pump shaft such that the pump shaft rotates in response to rotation of the turbine shaft.

### FIELD OF THE DISCLOSURE

The present disclosure relates to efficiencies in operating a gas-oil separation plant (GOSP), and more specifically, to utilizing power losses in a high-pressure inlet stream to pressurize another low-pressure fluid stream within the plant.

### BACKGROUND OF THE DISCLOSURE

Crude oil produced from a subterranean wellbore often contains mixtures of water and various hydrocarbons. The crude oil may be transported to a GOSP facility where the hydrocarbons (oil and associated, gas) may be separated from the water and the resulting fluid streams may be directed to individual locations for further processing. Typically, a GOSP facility has two or three oil-gas separation stages and two or three dehydrator stages. As the crude oil is sent through the separation system, its pressure is reduced at each stage, and the associated gas is released in a separator. The associated gas is then compressed before it is sent to the gas train facility for further processing. The remaining crude may then be processed in a stabilization plant where light end components and hydrogen sulfide are removed to stabilize the crude. This stabilized crude may then exported. As for the water, this byproduct is normally pumped to a water handling facility within the GOSP facility for additional treatment. Often, the treated water is then pumped into a subterranean reservoir for disposal as part of a pressure maintenance program.

Generally, the crude oil is fed to the GOSP facility under high pressures. These high pressures are often regulated by an inlet pressure control valve, where some of the energy in the high-pressure inlet stream is dissipated.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a gas-oil separation plant (GOSP) system includes a crude inlet line extending from a source of a fluid inlet stream and an inlet pressure control valve coupled within the crude inlet line and operable to control a pressure of the fluid inlet stream passing therethrough. A separation vessel is coupled to the crude inlet line downstream of the inlet pressure control valve, and is operable to separate a water component from the inlet fluid stream. A water line is coupled to the separation vessel and a water draw-off pump is coupled within the water line. The water draw-off pump includes a shaft operably rotatable to draw the water component through the water line from the separation vessel, and a turbine is coupled within the crude inlet line upstream of the inlet pressure control valve. The turbine includes a turbine shaft rotatable in response to the inlet fluid stream flowing therethrough, wherein the turbine shaft is operably coupled to the pump shaft such that the pump shaft rotates in response to rotation of the turbine shaft.

According to another embodiment consistent with the present disclosure, a method for operating a GOSP system includes (a) flowing an inlet fluid stream into a crude inlet line, (b) passing the inlet fluid stream through a turbine coupled within the crude inlet line to rotate a turbine shaft of the turbine, (c) adjusting a pressure of the inlet fluid stream with an inlet pressure control valve coupled within the crude inlet line downstream of the turbine, (d) separating a water component from the inlet fluid stream with a separation vessel coupled to the crude line downstream of the inlet pressure control valve, and (c) drawing off the water component from the separation vessel through a water line with a water draw-off pump coupled within the water line and operably coupled to the turbine such that rotation of the turbine shaft induces rotation of a pump shaft of the water draw-off pump.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a partial schematic view of a gas-oil separation plant (GOSP), illustrating a crude inlet line extending to a three-phase separation vessel, wherein the three-phase separation vessel has a gas line, an oil line and a water line extending therefrom.

FIG. 2 is a partial schematic view of a GOSP including a turbine coupled within the crude inlet line and a water draw-off pump within the water line and operably coupled to the turbine in accordance with one or more aspects of the present disclosure.

FIG. 3 is flowchart illustrating a procedure for operating the GOSP of FIG. 2 to operate the water draw-off pump with power generated from the turbine in accordance with one or more aspects of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to a GOSP having a turbine positioned upstream of an inlet control valve in the crude inlet line of the GOSP. The turbine captures energy that might otherwise be lost from a pressure letdown at the inlet valve, and uses the energy to power other equipment in the GOSP, such as a water draw-off pump. The water draw off pump may be positioned within a water line of the GOSP extending from a separator vessel. A level controller may detect a level of water accumulating within the separator vessel and, based on the level detected, control the speed of the turbine to thereby control operational parameters of the water-draw off pump. The level controller may control the speed of the turbine by controlling an amount of fluid passing through the turbine.

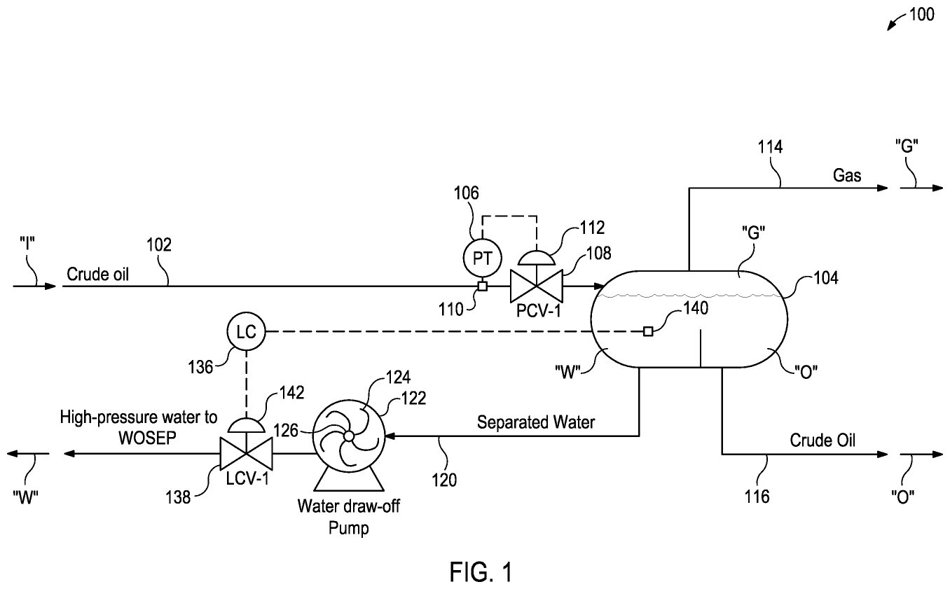

FIG. 1 is a schematic diagram of an example GOSP system 100 including a crude inlet line 102 extending to a separation vessel 104. The crude inlet line 102 may be a transmission pipeline extending from a source of a high-pressure fluid inlet stream “I”, such as the wellhead(s) of one or more hydrocarbon-producing wellbores (not shown). During the production life of the hydrocarbon-producing wellbores, a mix of crude oil and hydrocarbon gases are produced to the surface and enter the crude inlet line 102 as a high-pressure inlet fluid stream “I” containing a variable proportion of water, which may be in both liquid and vapor forms. It is important that at least a particular amount or proportion of the water be removed from the inlet fluid stream “I” in order to avoid the corrosion of downstream piping, fittings, instrumentation and the like.

The inlet fluid stream “I” may be controlled by an inlet controller 106, which may be operatively coupled to an inlet pressure control valve 108 (PCV-1) and communicatively coupled to one or more inlet sensors 110 upstream of the inlet pressure control valve 108 (PCV-1) in the crude inlet line 102. The one or more inlet sensors 110 may monitor conditions of the inlet fluid stream “I”, such as temperature and pressure, and provide readings to the inlet controller 106. The inlet controller 106 may compare these readings to set points indicative of desired conditions for the fluid stream to enter the separator vessel 104. The inlet controller 106 calculates an adjustment position for the inlet pressure control valve 108 (PCV-1), and instructs an actuator 112 of the pressure control valve 108 (PCV-1) to adjust the position pressure control valve 108 appropriately to prepare the fluid stream for entering the separation vessel 104. In many embodiments, the set points are determined at the design stage of the GOSP system 100 and remain fixed throughout the operational life of the GOSP system. In other embodiments, the inlet controller 106 may be manipulated to alter the set points indicative of desired conditions for the fluid stream to enter the separation vessel 104.

In some embodiments, the inlet controller 106 (and the level controller 136 described below) may be a computer-based system that may include a processor, a memory storage device, and programs and instructions, accessible to the processor for executing the instructions utilizing the data stored in the memory storage device to carry out the processes described herein. Additionally or alternatively, the controllers 106, 136 may include manual controls that may be manipulated by an operator to control any of the procedures and equipment described herein.

In the illustrated embodiment, the separation vessel 104 is a horizontal three-phase separation vessel, which generally uses gravity to separate a gas component “G”, an oil component “O” and a water component “W” from the inlet fluid stream “I” received from the crude inlet line 102. In some embodiments, the separation vessel 104 may alternatively or additionally employ various other methods of separating the components “G”, “O” and “W” including impingement, changing a flow direction and/or velocity of the fluid stream and/or application of a centrifugal force. A gas line 114 and an oil line 116 extend from the separation vessel 104 to carry the gas and oil components “O” and “G”, respectively, from the separation vessel 104 for further processing. For example, the oil line 116 may carry the oil component “O” to an additional stage separation vessel (not shown). A water line 120 extends from the separation vessel 104 to a water draw-off pump 122, which pressurizes the water component “W” for delivery to a water/oil separation plant (not shown) for further processing, a wastewater vessel (not shown) or for disposal or another appropriate destination.

Although FIG. 1 illustrates only one water draw-off pump 122, it should be appreciated that a plurality of water draw-off pumps 122 may be employed without departing from the scope of the disclosure. In some embodiments, a GOSP system 100 may include three water draw-off pumps 122, where two of the water draw-off pumps 122 are designed to operate together while the third water draw-off pump 122 is provided as a standby if needed. The plurality of water draw-off pumps may be coupled within the crude inlet line 102 in parallel, in series, or any other appropriate configuration.

The water draw off-pump 122 may be a centrifugal pump, which employs one or more impellers 124 that attach to and rotate with a pump shaft 126. The pump shaft 126 may be rotated by an electric motor (not shown), which provides the energy that moves the water component “W” through the water draw-off pump 122 and pressurizes the water to move it through the water line 120. The water draw-off pump 122 therefore converts mechanical energy from the motor to energy of a moving fluid stream, e.g., the water component “W”. A portion of the energy is converted to kinetic energy, e.g., the motion of the water component “W”, and a portion of the energy is converted into potential energy, represented by an increased fluid pressure in the water component “W”.

A water fluid stream discharged from the water draw-off pump 122 may be controlled by a level controller 136. The level controller 136 may be operatively coupled to a level control valve 138 (LCV-1) and one or more level control sensors 140 within the separation vessel 104. The one or more level control sensors 140 may detect a level of the water component “W” in the separation vessel 104 and provide readings indicative of the level to the level controller 136. The level controller 136 may compare these readings to set points indicative of desired level for the water component “W” in the separator vessel 104. The level controller 136 calculates an adjustment position for the level control valve 138, and instructs an actuator 142 of the level control valve 138 to adjust the position level control valve 138 appropriately. For example, the level controller 136 may instruct the level control valve 138 to open if the one or more level control sensors 140 detect a level of the water component “W” above a particular threshold and to close if the one or more level control sensors detect level of the water component “W” below the particular threshold.

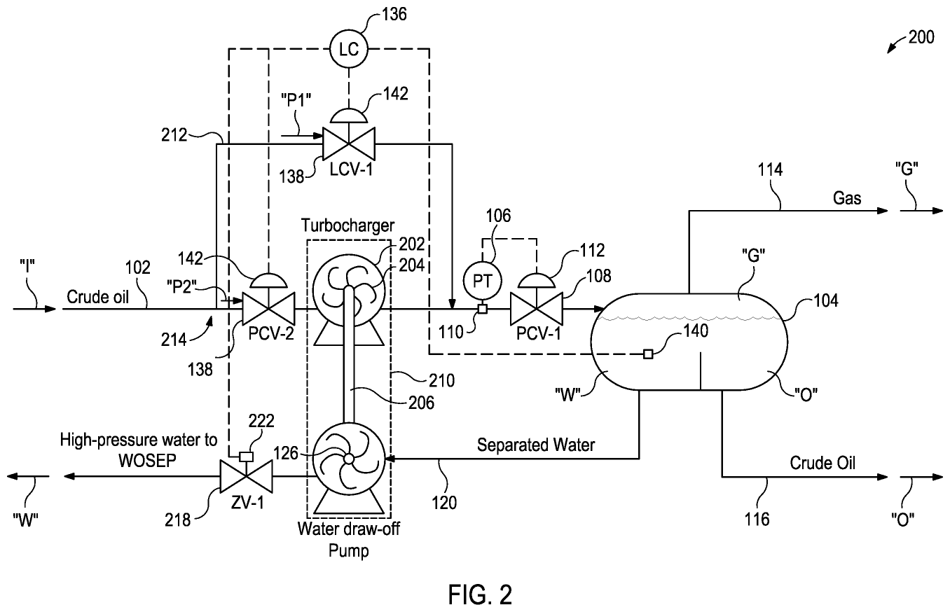

Referring now to FIG. 2, in accordance with one or more aspects of the present disclosure, a schematic diagram of an example GOSP system 200 is illustrated including a turbine 202 upstream of the inlet control valve 108. The turbine 202 is coupled within the crude inlet line 102 such that the high-pressure inlet fluid stream “I” passes through the turbine 202. The high-pressure inlet fluid stream “I” may impinge upon or more turbine impellers 204 within the turbine 202 such that the turbine impellers 240 are induced to rotate about a turbine shaft 206. The rotation of the turbine shaft 206 may be used to power other components of the GOSP system 200. In the illustrated embodiment, the turbine shaft 206 is operatively coupled to the pump shaft 126 of the water draw-off pump 122. Together, the turbine 202 and the water draw-off pump 122 define a turbocharger 210 that uses energy extracted from the high-pressure inlet stream to pressurize water component “W” in the water line 120.

In the illustrated embodiment, the turbine shaft 206 is directly coupled to the pump shaft 126 such that both the pump shaft 126 and the turbine shaft 206 rotate together at the same rotational speed. In other embodiments, the pump shaft 126 may be indirectly coupled to the turbine shaft 206, e.g., through a gearbox or other mechanism (not shown), such that a rotational speed of the pump shaft 126 is positively correlated to a rotational speed of the turbine shaft 206. For example, when the speed of the turbine shaft 206 increases, the speed of the pump shaft 126 increases, and similarly, when the speed of the turbine shaft 206 decreases, the speed of the pump shaft 126 correspondingly decreases.

A bypass line 212 branches from the crude inlet line 102 at a branch 214 upstream of the turbine 202. The bypass line 212 extends around the turbine 202 and re-joins the crude inlet line 102 between the turbine 202 and the one or more inlet sensors 110. First and second level control valves 138 are provided to control the proportions of a first portion “P1” and a second portion “P2” of the inlet fluid stream “I” passing through the turbine 202 and the bypass line 212. A first level control valve 138 (LCV-1) is provided within the bypass line 212 and a second level control valve 138 (LCV-2) is provided within the crude inlet line 102 between the branch 214 and the turbine. The first and second level control valves 138 each include an actuator 142 operably coupled to the level controller 136, which is operably coupled to one or more level control sensors 140 within the separation vessel 104 as described above.

In operation of the example of GOSP 200 system, when the one or more level control sensors 140 detect an increase in the level of the water component “W” within the separation vessel 104 (or detect level of the water component “W” greater than a particular threshold), the level controller 136 may instruct the actuators 142 to partially close the first level control valve 138 (LCV-1) and further open the second level control valve 138 (LCV-2). A lesser proportion of the inlet fluid stream “I” will be induced to pass through the bypass line 212 and greater proportion of the inlet fluid stream “I” will be induced to pass through the turbine 202, i.e., “P1” will decrease and “P2” will increase. The impellers 204 and the turbine shaft 206 will speed up, causing the pump shaft 126 and impellers 124 of the water draw-off pump 122 to speed up. Consequently, the water draw-off pump 122 will draw off more of the water component “W” from the separation vessel 104 until the one or more level control sensors 140 detect a sufficient decrease in the level of water component “W.” When the one or more level control sensors 140 detect a decrease of the level or the water component “W” to below the particular threshold, the level controller 136 may instruct the actuators 142 to further open the first level control valve 138 (LCV-1) and partially close the second level control valve 138 (LCV-2) to slow down the water draw-off pump 122. In this manner, the level controller 136 may operate to maintain the level of the water component “W” within a desired range around the particular threshold.

In some example embodiments, the water line 120 may include a safety valve 218 coupled therein. The safety valve 218 may be operable to close the water line 120 and prevent the water component “W” from flowing to the water/oil separation plant (not shown) for further processing, a wastewater vessel (not shown) or for disposal or another appropriate destination. In operation, if the one or more level control sensors 140 detect a decrease of the level or the water component “W” to below a lower threshold, the level controller 136 may instruct the actuator 142 of the second level control valve 138 (LCV-2) to fully close the second level control valve 138 (LCV-2) and instruct an actuator 222 to close the safety valve 218. The entire inlet fluid stream “I” will be directed through the bypass line 212 and the turbocharger 210 may remain inactive.

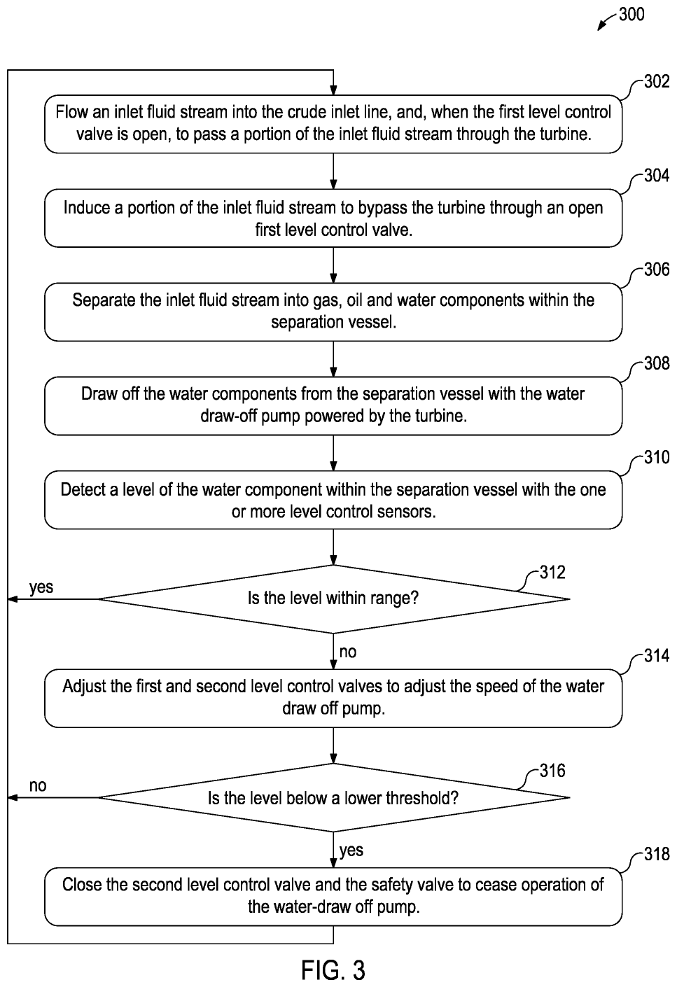

Referring now to FIG. 3, and with continued reference to FIGS. 1 and 2, a procedure 300 is described for operating the GOSP system 200. Initially at step 302, the inlet fluid stream “I” is flowed into the crude inlet line 102 with the second level control valve 138 (LCV-2) in an open configuration. A portion of the inlet fluid stream “I” is passed though the turbine 202 to rotate the turbine shaft 206. Although FIG. 2 illustrates only one turbine 202, it should be appreciated that a plurality of turbines 202 may be employed without departing from the scope of the disclosure. The rotation of the turbine shaft 206 induces rotation of the pump shaft 126. At step 304, a portion of the inlet fluid stream “I” is induced to flow through the bypass line 212 and through the first level control valve 138 (LCV-1). Steps 302 and 304 may be conducted concurrently such that the inlet fluid stream “I” is split at branch 214 and recombined downstream of the turbine 202. The recombined inlet fluid stream “I” is passed through the inlet pressure control valve 108, and thereby prepared for entry into the separation vessel 104 by the inlet controller 106.

At step 306, the inlet fluid stream “I” enters the separation vessel 104 and separated into gas “G”, oil “O” and water “W” components. At step 308, the water component “W” is drawn off from the separation vessel 104 with the water draw-off pump 122. Since the pump shaft 126 of the water draw-off pump 122 is induced to rotate by the rotation of the turbine shaft 206, the water draw-off pump 122 is powered by the turbine 202. At step 310, a level of the water component “W” within the separation vessel is detected by the one or more level control sensors 140. Steps 302 through 310 may all be performed concurrently.

At decision 312, the level controller 136 may determine whether the detected level is within a predetermined range. For example, the level controller 136 may compare the detected level to an upper operating threshold and a lower operating threshold defining the boundaries of the desired operating range. If the detected level is between the upper operating threshold and the lower operating threshold, the procedure 300 may return to step 302 where the inlet fluid stream “I” may continue to flow through the turbine 202, and thereby continue to operate the water draw-off pump. If the detected level is outside the desired operating range, the procedure may proceed to step 314 where the first and second level control valves 138 (LCV-1 and LCV-2) are adjusted.

At step 314, if the measured level is above the upper operating threshold, the level controller 136 may instruct the actuators 142 to partially close the first level control valve 138 (LCV-1) and further open the second level control valve 138 (LCV-2). Adjusting the level control valves 138 in this manner increases the proportion of the inlet fluid stream “I” flowing through the turbine 202 and decreases the proportion of the inlet fluid stream “I” flowing through the bypass line 212. The turbine shaft 206 may consequently rotate at a greater rate and drive the pump shaft 126 at an increased rate. The level of the water component “W” within the separation vessel 104 may consequently decrease as the water draw-off pump 122 pumps the water component “W” through the water line at a greater rate. The level of the water component “W” may consequently return to being within the desired operating range.

Similarly, at step 314, if the measured level is below the lower operating threshold, at step 314 the level controller 136 may instruct the actuators 142 to further open the first level control valve 138 (LCV-1) and partially close the second level control valve 138 (LCV-2). These adjustments decrease the proportion of the inlet fluid stream “I” flowing through the turbine 202 and increase the proportion of the inlet fluid stream “I” flowing through the bypass line 212. The turbine 202 and the water draw-off pump 122 may consequently operate at a slower rate, allowing the water component “W” to accumulate within the separation vessel 104.

The procedure 300 may then continue to decision 316 where the level controller 136 determines whether the detected level of the water component “W” within the separation vessel 104 is below a lower safety threshold at which the turbine 202 and the water draw-off pump 122 may be operated safely. If the level of the water component “W” within the separation vessel 104 were to fall below the lower safety threshold, gasses, such as the gas component “G”, could be drawn to the water draw-off pump 122 causing cavitation and damage within the water draw-off pump 122. Thus, the lower safety threshold may be selected to prevent the unintended escape of gasses from the separation vessel 104. If the measured level is not below the lower safety threshold, the procedure 300 may return to step 302 where the inlet fluid stream “I” may continue to flow through the turbine 202. Any adjustments made in step 314 may be permitted to take effect, and the level of the water component “W” within the separation vessel may be permitted to return to the desired operating range. However, if the measured level is determined to be below the lower safety threshold, the procedure 300 may proceed to step 318.

At step 318, the level controller 136 may instruct the actuators 142 to completely close the second level control valve 138 (LCV-2), and thereby prohibit flow of the inlet fluid stream “I” through the turbine 202. The entire inlet fluid stream “I” may be permitted to flow through the bypass line 312, and the first level control valve 138 (LCV-1) may be fully opened if necessary. The turbine 202 and the water draw-off pump 122 may cease operation such that the water component “W” may accumulate in the separation vessel 104. In some embodiments, the safety valve 218 may be closed in response to the complete closure of the second level control valve 138 (LCV-2). In some embodiments, the level controller 136 may provide instructions to the actuator 222 to close the safety valve 218, and in other embodiments, the safety valve 218 may be closed manually by an operator.

Once step 318 is complete, the procedure 300 returns to step 302, where the inlet fluid stream “I” may be flowed into the crude inlet line 102. Since the second level control valve 138 (LCV-2) is in a closed configuration, the inlet fluid stream “I” may pass through the bypass line 212 until the water component “W” accumulates in the separation vessel at least to the lower safety threshold, and in some embodiments, to the lower operational threshold. The second level control valve 138 (LCV-2) and the safety valve 218 (ZV-1) may then be opened, and the procedure 300 may continue in as a continuous process.

It should be appreciated that the steps of procedure 300 may be conducted in alternate orders. Also not every step may be performed in every procedure for operating the GOSP system 200.

### EXAMPLE(S)

In the example procedure 300, preferably, the power required to operate the water draw-off pump 122 (or pumps) is generated entirely from the inlet fluid stream “I” flowing through the turbine 202. Typical water draw-off pumps 122 for a Low Pressure Production Trap (LPPT) of a GOSP system 200, such as separation vessel 104, may require about 50 horsepower to about 70 horsepower for each pump. Thus, embodiments where two water draw-off pumps 122 are operational, the GOSP system 200 may require about 100 horsepower to about 140 horsepower to operate the water draw-off pumps 122.

In some example GOSP systems, a fluid inlet stream “I’ of 440 million barrels per day (MBD), or 300 MBD dry crude, with about a 30% water cut arrives at a pressure of 75 PSIG and a temperature of 120° F. Such an inlet fluid stream can generate from about 500 horsepower to about 600 horsepower after passing through a turbine 202 with a resulting pressure drop of only about 15 PSI. Accordingly, the fluid inlet stream “I” may be sufficient to produce about five times the power required to operate two water draw-off pumps 122, depending of the composition of the fluid inlet stream “I”. Even during a turndown operation, where the GOSP system 200 operates at about 33% of total capacity, the power generate may be about 150 horsepower to about 200 horsepower. Thus, the turbine 202 (or turbines) in a GOSP system 200 may generate sufficient power to operate the water draw-off pump 122 (or pumps).

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A gas-oil separation plant (GOSP) system, comprising:
a crude inlet line extending from a source of a fluid inlet stream;
an inlet pressure control valve coupled within the crude inlet line and operable to control a pressure of the fluid inlet stream passing therethrough;
a separation vessel coupled to the crude inlet line downstream of the inlet pressure control valve, the separation vessel operable to separate a water component from the inlet fluid stream;
a water line coupled to the separation vessel;
a water draw-off pump coupled within the water line, the water draw-off pump including a shaft operably rotatable to draw the water component through the water line from the separation vessel; and
a turbine coupled within the crude inlet line upstream of the inlet pressure control valve, the turbine including a turbine shaft rotatable in response to the inlet fluid stream flowing therethrough, wherein the turbine shaft is operably coupled to the pump shaft such that the pump shaft rotates in response to rotation of the turbine shaft.

2. The GOSP system of claim 1, further comprising a bypass line branching from the crude inlet line at a branch upstream of the turbine and re-joining the crude inlet line downstream of the turbine.

3. The GOSP system of claim 2, further comprising a first level control valve coupled within the bypass line and a second level control valve coupled within the crude inlet line between the branch and the turbine, the first and second level control valves operable to control a proportion of the inlet fluid stream flowing through each of the bypass line and the turbine.

4. The GOSP system of claim 3, further comprising a level controller operably coupled to the first and second level control valves to selectively instruct the first and second level control valves to open and close to thereby adjust the proportion of the inlet fluid stream flowing through the bypass line and the turbine.

5. The GOSP system of claim 4, further comprising a level control sensor operable to detect a level of the water component within the separation vessel and communicably coupled to the level controller, wherein the level controller is operable to adjust the first and second level control valves based on the level of the water component within the separation vessel.

6. The GOSP system of claim 5, further comprising a safety valve coupled within the water line downstream of the water draw-off pump, and wherein the level controller is operatively coupled to the safety valve to close the safety valve when the second level control valve is closed.

7. The GOSP system of claim 1, further comprising an inlet controller communicatively coupled to one or more inlet sensors operable to detect a pressure of the inlet fluid stream upstream of the inlet pressure control valve, wherein the inlet controller is operatively coupled to the inlet pressure control valve to adjust the inlet pressure control valve based on a pressure detected by the one or more inlet sensors.

8. The GOSP system of claim 1, wherein the separation vessel is a three-phase separation vessel for separating the water component from the inlet fluid stream as well as separating a gas component and an oil component from the inlet fluid stream.

9. A method for operating a GOSP system, the method comprising:
flowing an inlet fluid stream into a crude inlet line;
passing the inlet fluid stream through a turbine coupled within the crude inlet line to rotate a turbine shaft of the turbine;
adjusting a pressure of the inlet fluid stream with an inlet pressure control valve coupled within the crude inlet line downstream of the turbine;
separating a water component from the inlet fluid stream with a separation vessel coupled to the crude line downstream of the inlet pressure control valve; and
drawing off the water component from the separation vessel through a water line with a water draw-off pump coupled within the water line and operably coupled to the turbine such that rotation of the turbine shaft induces rotation of a pump shaft of the water draw-off pump.

10. The method of claim 9, further comprising bypassing the turbine with a first portion of the inlet fluid stream by flowing the first portion through a bypass line branching from the crude inlet line at a branch upstream of the turbine and re-joining the crude inlet line downstream of the turbine.

11. The method of claim 10, further comprising flowing the first portion of the inlet fluid steam through a first level control valve coupled within the bypass line and flowing a second portion of the inlet fluid stream through a second level control valve coupled within the crude inlet line between the branch and the turbine.

12. The method of claim 11, further comprising:
detecting a level of the water component within the separation vessel with a level control sensor; and
adjusting the first and second level control valves based on the level detected.

13. The method of claim 12, further comprising closing the second level control valve in response to detecting the level of water component within separation vessel below a lower operational threshold.

14. The method of claim 14, further comprising closing a safety valve in the water line downstream of the water draw-off pump in response closing the second level control valve.

15. The method of claim 9, further comprising adjusting the inlet pressure control valve based on a pressure detected by one or more inlet sensors upstream of the inlet pressure control valve.
